(19) United States
(12) Patent Application Publication
(10) Pub. No.: US 2024/0289633 A1
(43) Pub. Date: Aug. 29, 2024

(54) INFORMATION PROCESSING SYSTEM, INFORMATION PROCESSING METHOD, AND RECORDING MEDIUM

(71) Applicant: NEC Corporation, Minato-ku, Tokyo (JP)

(72) Inventor: Makoto Takamoto, Tokyo (JP)

(73) Assignee: NEC Corporation, Minato-ku, Tokyo (JP)

(21) Appl. No.: 18/290,346

(22) PCT Filed: May 17, 2021
(86) PCT No.: PCT/JP2021/018619

§ 371 Date: Nov. 13, 2023

(51) Int. Cl. G06N 3/096

(52) U.S. Cl. CPC G06N 3/096

(57) ABSTRACT

An information processing system includes: a data input unit that inputs labeled data and unlabeled data; a pseudo-label addition unit that adds a pseudo-label to the unlabeled data, by using a teacher model learned by using the labeled data; a pseudo-label evaluation unit that evaluates the pseudo-label, by using an evaluation model learned by using at least one of the labeled data and the unlabeled data, and outputs the pseudo-label that reaches a predetermined evaluation criterion, as an evaluation pseudo-label; a student model learning unit that learns a student model, by using the labeled data, and pseudo-labeled data in which the evaluation pseudo-label is added; and a model output unit that outputs the learned student model.

### TECHNICAL FIELD

This disclosure relates to technical fields of an information processing system, an information processing method, and a recording medium.

### BACKGROUND ART

A known system of this type adds a pseudo-label to unlabeled data. For example, Patent Literature 1 discloses a technique/technology of adding a positive example label or a negative example label to a feature vector of a pixel with no label. Patent Literature 2 discloses a technique/technology of calculating a score using a ratio of labels that are close in distance or the like and setting the score for unlabeled data, thereby to generate learning data to which a pseudo-label is added.

As another related technique/technology, Patent Literature 3 discloses a technique/technology of learning a rule of conversion from an original domain to a target domain, by using labeled data of the original domain and unlabeled data of the target domain.

### CITATION LIST

### Patent Literature

Patent Literature 1: JP2020-047055A
Patent Literature 2: JP2019-159576A
Patent Literature 3: JP2019-101789A

### SUMMARY

### Technical Problem

This disclosure aims to improve the techniques/technologies disclosed in Citation List.

### Solution to Problem

An information processing system according to an example aspect of this disclosure includes: a data input unit that inputs labeled data and unlabeled data; a pseudo-label addition unit that adds a pseudo-label to the unlabeled data, by using a teacher model learned by using the labeled data; a pseudo-label evaluation unit that evaluates the pseudo-label added to the unlabeled data, by using an evaluation model learned by using at least one of the labeled data and the unlabeled data, and outputs the pseudo-label that reaches a predetermined evaluation criterion, as an evaluation pseudo-label; a student model learning unit that learns a student model, by using the labeled data, and pseudo-labeled data obtained by adding the evaluation pseudo-label to the labeled data; and a model output unit that outputs the learned student model.

An information processing method according to an example aspect of this disclosure includes: inputting labeled data and unlabeled data; adding a pseudo-label to the unlabeled data, by using a teacher model learned by using the labeled data; evaluating the pseudo-label added to the unlabeled data, by using an evaluation model learned by using at least one of the labeled data and the unlabeled data, and outputting the pseudo-label that reaches a predetermined evaluation criterion, as an evaluation pseudo-label; learning a student model, by using the labeled data, and pseudo-labeled data obtained by adding the evaluation pseudo-label to the labeled data; and outputting the learned student model.

A recording medium according to an example aspect of this disclosure is a recording medium on which a computer program that allows a computer to execute an information processing method is recorded, the information processing method including: inputting labeled data and unlabeled data; adding a pseudo-label to the unlabeled data, by using a teacher model learned by using the labeled data; evaluating the pseudo-label added to the unlabeled data, by using an evaluation model learned by using at least one of the labeled data and the unlabeled data, and outputting the pseudo-label that reaches a predetermined evaluation criterion, as an evaluation pseudo-label; learning a student model, by using the labeled data, and pseudo-labeled data obtained by adding the evaluation pseudo-label to the labeled data; and outputting the learned student model.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a block diagram illustrating a functional configuration of an information processing system according to a second example embodiment.

FIG. 5 is a flowchart illustrating a flow of operation of the information processing system according to the second example embodiment.

FIG. 6 is a block diagram illustrating a method of learning an evaluation model in an information processing system according to a third example embodiment.

FIG. 7 is a block diagram illustrating a method of learning the evaluation model in an information processing system according to a fourth example embodiment.

FIG. 8 is a block diagram illustrating a method of learning the evaluation model in an information processing system according to a fifth example embodiment.

FIG. 9 is a block diagram illustrating a method of learning the evaluation model in an information processing system according to a sixth example embodiment.

FIG. 10 is a block diagram illustrating a configuration of a model evaluation unit in an information processing system according to a seventh example embodiment.

FIG. 11 is a block diagram illustrating a functional configuration of an information processing system according to an eighth example embodiment.

FIG. 12 is a flowchart illustrating a flow of operation of the information processing system according to the eighth example embodiment.

FIG. 13 is a block diagram illustrating a functional configuration of an information processing system according to a ninth example embodiment.

FIG. 14 is a flowchart illustrating a flow of operation of the information processing system according to the ninth example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

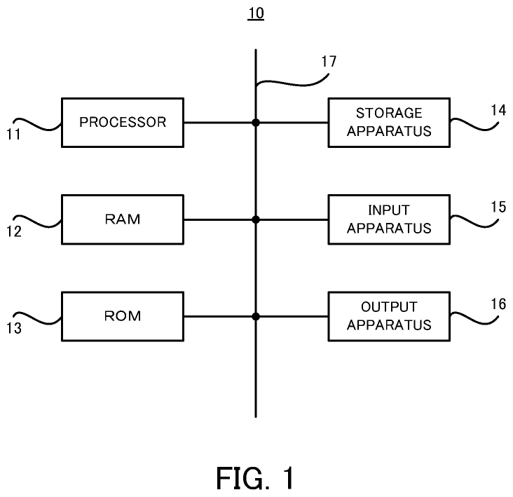

An information processing system according to a first example embodiment will be described with reference to FIG. 1 to FIG. 3.

### (Hardware Configuration)

First, a hardware configuration of an information processing system 10 according to the first example embodiment will be described with reference to FIG. 1. FIG. 1 is a block diagram illustrating the hardware configuration of the information processing system according to the first example embodiment.

As illustrated in FIG. 1, the information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13, and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for performing a process related to machine learning is realized or implemented in the processor 11.

The processor 11 may be configured as, for example, a CPU (Central Processing Unit), a GPU (Graphics Processing Unit), a FPGA (field-programmable gate array), a DSP (Demand-Side Platform) or an ASIC (Application Specific Integrated Circuit). The processor 11 may include one of them, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM 5 (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the information processing system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel.

The output apparatus 16 is an apparatus that outputs information about the information processing system 10 to the outside. For example, the output apparatus 16 may be a display apparatus (e.g., a display) that is configured to display the information about the information processing system 10.

### (Functional Configuration)

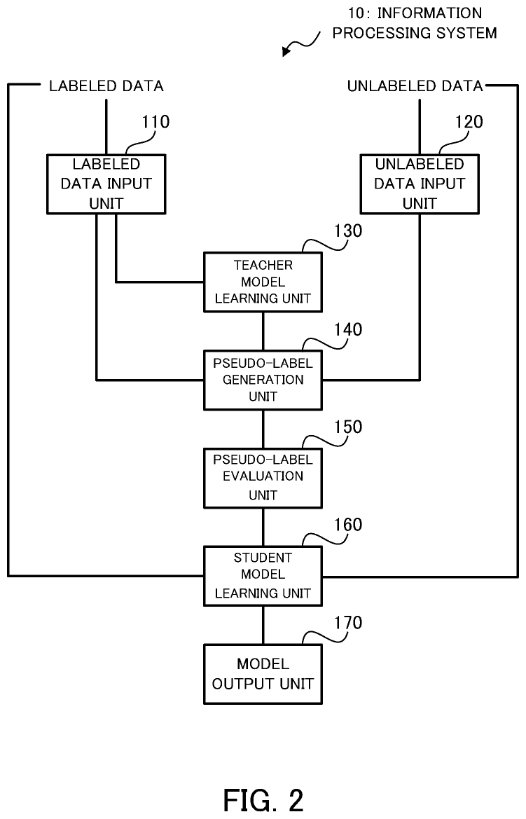

Next, a functional configuration of the information processing system 10 according to the first example embodiment will be described with reference to FIG. 2. FIG. 2 is a block diagram 30 illustrating the functional configuration of the information processing system according to the first example embodiment.

As illustrated in FIG. 2, the information processing system 10 according to the first example embodiment includes, as processing blocks for realizing the functions thereof, a labeled data input unit 110, an unlabeled data input unit 120, a teacher model learning unit 130, a pseudo-label generation unit 140, a pseudo-label evaluation unit 150, a student model learning unit 160, and a model output unit 170. Each of the labeled data input unit 110, the unlabeled data input unit 120, the teacher model learning unit 130, the pseudo-label generation unit 140, the pseudo-label evaluation unit 150, the student model learning unit 160, and the model output unit 170 may be realized or implemented by the processor 11 (see FIG. 1), for example.

The labeled data input unit 110 is configured to input labeled data. The unlabeled data input unit 120 is configured to input unlabeled data. The “label” here is information indicating a correct answer (a so-called correct answer label) added to the data, and the “labeled data” are data to which the correct answer label is added, and the “unlabeled data” are data to which the correct answer label is not added. An example of the labeled data and the unlabeled data includes image data. The image data may include an eye area or a facial area of a living body. The image data may be data including a plurality of consecutive images in a time series (i.e., video data separated by a predetermined time). Although described here is such a configuration that the labeled data and the unlabeled data are inputted from the separate input units, the labeled data and the unlabeled data may be inputted from one common input unit. For example, in place of the labeled data input unit 110 and the unlabeled data input unit 120, one data input unit that is configured to input both the labeled data and the unlabeled data may be provided.

The teacher model learning unit 130 is configured to learn a teacher model by using the labeled data inputted to the labeled data input unit 110. The teacher model here is a model for generating a pseudo-label to be added to the unlabeled data. The “pseudo-label” is a pseudo-correct answer label, and is generated by a model that is learned by using the labeled data. A detailed description of a specific method of learning the teacher model will be omitted here, because the existing techniques/technologies may be adopted to the method as appropriate. When the teacher model (and each of models described later) is learned, for example, Consistency Regularization may be used to improve accuracy. The information processing system 10 according to the first example embodiment may not include the teacher model learning unit 130. In this case, the learning of the teacher model by the labeled data may be performed outside the system, and the learned teacher model may be inputted to the information processing system 10.

The pseudo-label generation unit 140 is configured to generate a pseudo-label to be added to the unlabeled data, by using the teacher model learned by the teacher model learning unit 130. The pseudo-label generation unit 140 is configured to add the generated pseudo-label to the unlabeled data.

The pseudo-label evaluation unit 150 is configured to evaluate the pseudo-label generated by the pseudo-label generation unit 140. Specifically, the pseudo-label evaluation unit 150 is configured to evaluate whether or not the generated pseudo-label reaches a predetermined evaluation criterion of the pseudo-label. Here, the “predetermined evaluation criterion” is a criterion for determining whether or not the quality of the pseudo-label is sufficiently high, and is set in advance. The pseudo-label evaluation unit 150 is configured to output the pseudo-label that reaches the predetermined evaluation criterion (an evaluation pseudo-label), but not to output the pseudo-label that does not reach the predetermined evaluation criterion. For example, when there is an error that is more than twice an average error in a test set of the labeled data, the pseudo-label evaluation unit 150 may evaluate and output the pseudo-label as low quality. In addition, when there is not an error that is more than twice the average error in the test set of the labeled data, the pseudo-label evaluation unit 150 may evaluate and output the pseudo-label as high quality.

The pseudo-label evaluation unit 150 is configured to evaluate the pseudo-label, by using an evaluation model that is learned by using at least one of the labeled data and the unlabeled data. A method of learning the evaluation model will be described in detail in another example embodiment later.

The student model learning unit 160 is configured to learn a student model, by using the labeled data, and the unlabeled data to which the evaluation pseudo-label outputted from the pseudo-label evaluation unit 150 is added (hereinafter referred to as “pseudo-labeled data” as appropriate). The student model here is, as in the teacher model, a model for generating the pseudo-label to be added to the unlabeled data. A detailed description of a method of learning the student model will be omitted here, because the existing techniques/technologies may be adopted to the method as appropriate. When the student model is learned, for example, an existing distillation method may be combined and used.

The model output unit 170 is configured to output the learned student model. Furthermore, the model output unit 170 may be configured to output the teacher model and the evaluation model in addition to the learned student model.

### (Flow of Operation)

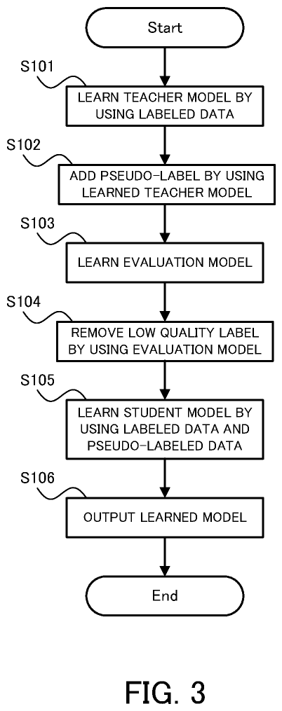

Next, a flow of operation of the information processing system 10 according to the first example embodiment will be described with reference to FIG. 3. FIG. 3 is a flowchart illustrating the flow of the operation of the information processing system according to the first example embodiment.

As illustrated in FIG. 3, in operation of the information processing system 10 according to the first example embodiment, first, the teacher model learning unit 130 learns the teacher model by using the labeled data inputted from the labeled data input unit 110 (step S101). Then, the pseudo-label generation unit 140 generates the pseudo-label by using the learned teacher model, and adds the pseudo-label to the unlabeled data inputted from the unlabeled data input unit 120 (step S102).

Subsequently, the pseudo-label evaluation unit 150 learns the evaluation model (step S103). Then, the pseudo-label evaluation unit 150 removes a low-quality pseudo-label of the pseudo-labels generated by the pseudo-label generation unit 140 (step S104). In other words, the pseudo-label evaluation unit 150 outputs only a high-quality evaluation pseudo-label.

Subsequently, the student model learning unit 160 learns the student model, by using the labeled data, and the pseudo-labeled data in which the evaluation pseudo-label is added (step S105). Thereafter, the model output unit 170 outputs the learned model (step S106).

### (Technical Effect)

Next, a technical effect obtained by the information processing system 10 according to the first example embodiment will be described.

As described in FIG. 1 to FIG. 3, in the information processing system 10 according to the first example embodiment, the learning using the high-quality pseudo-label (i.e., the pseudo-label outputted as a result of the evaluation) is performed by evaluating the generated pseudo-label. In this way, it is possible to add an appropriate pseudo-label to the unlabeled data. More specifically, it is possible to add the pseudo-label to the unlabeled data with high accuracy when dealing with a regression problem. Therefore, it is possible to reduce a cost of adding a label to the unlabeled data, for example.

### Second Example Embodiment

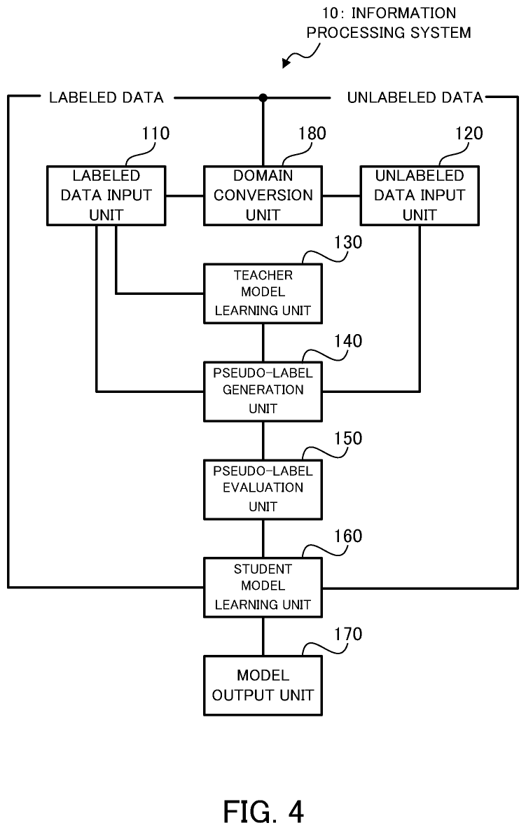

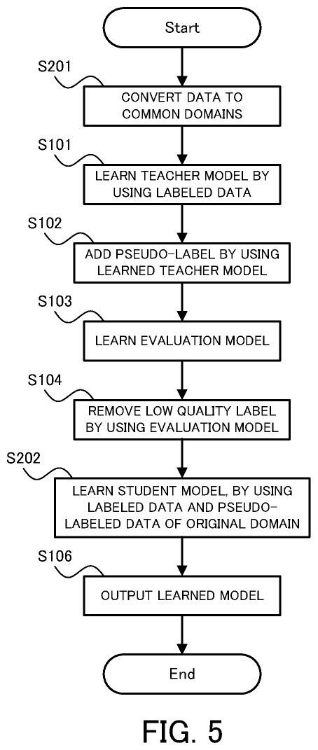

The information processing system 10 according to a second example embodiment will be described with reference to FIG. 4 and FIG. 5. The second example embodiment is partially different from the first example embodiment only in the configuration and operation, and may be the same as the first example embodiment in the other parts. For this reason, a part that is different from the first example embodiment described above will be described in detail below, and a description of other overlapping parts will be omitted as appropriate.

### (Functional Configuration)

First, a functional configuration of the information processing system 10 according to the second example embodiment will be described with reference to FIG. 4. FIG. 4 is a block diagram illustrating the functional configuration of the information processing system according to the second example embodiment. In FIG. 4, the same components as those illustrated in FIG. 2 carry the same reference numerals.

As illustrated in FIG. 4, the information processing system 10 according to the second example embodiment includes, as processing blocks for realizing the functions thereof, the labeled data input unit 110, the unlabeled data input unit 120, the teacher model learning unit 130, the pseudo-label generation unit 140, the pseudo-label evaluation unit 150, the student model learning unit 160, the model output unit 170, and a domain conversion unit 180. That is, the information processing system 10 according to the second example embodiment further includes the domain converter 180, in addition to the configuration in the first example embodiment (see FIG. 2).

The domain conversion unit 180 is configured to convert the labeled data before being inputted to the labeled data input unit 110 and the unlabeled data before being inputted to the unlabeled data input unit 120, into domains that are common to each other. That is, the domain conversion unit 180 is configured to perform a process of matching the domain for the labeled data with the domain for the unlabeled data. The domain after the conversion may be a domain that is completely different from the original domain. That is, the labeled data and the unlabeled data may be converted into a third domain that is different from their original domains.

The process performed by the domain conversion unit 180 may be an image conversion process when the data are image data. For example, the domain conversion unit 180 may perform a process in which a Laplacian filter is applied to an image, thereby to convert the original data to the data in which an edge of the image is detected. Furthermore, the domain conversion unit 180 may convert the domain by a Style Transfer (e.g., AdaIN). Alternatively, the domain conversion unit 180 may convert the domain by changing illumination or resolution. The domain conversion unit 180 may extract a feature quantity of the data, and may calculate a distance between the domains by using Kullback-Leibler divergence from the feature quantity.

### (Flow of Operation)

Next, a flow of operation of the information processing system 10 according to the second example embodiment will be described with reference to FIG. 5. FIG. 5 is a flowchart illustrating the flow of the operation of the information processing system according to the second example embodiment. In FIG. 5, the same steps as those illustrated in FIG. 3 carry the same reference numerals.

As illustrated in FIG. 5, in operation of the information processing system 10 according to the second example embodiment, first, the domain conversion unit 180 converts the labeled data and the unlabeled data into the domains that are common to each other (step S201). The labeled data and unlabeled data after the domain conversion are inputted to the labeled data input unit 110 and the unlabeled data input unit 120, respectively.

Subsequently, the teacher model learning unit 130 learns the teacher model by using the labeled data inputted from the labeled data input unit 110 (step S101). Then, the pseudo-label generation unit 140 generates the pseudo-label by using the learned teacher model, and adds the pseudo-label to the unlabeled data inputted from the unlabeled data input unit 120 (step S102).

Subsequently, the pseudo-label evaluation unit 150 learns the evaluation model (step S103). Then, the pseudo-label evaluation unit 150 removes a low-quality pseudo-label of the pseudo-labels generated by the pseudo-label generation unit 140 (step S104).

Subsequently, the student model learning unit 160 learns the student model, by using the labeled data before the domain conversion, and the pseudo-labeled data obtained by adding the evaluation pseudo-label to the unlabeled data before the domain conversion (step S202). Thereafter, the model output unit 170 outputs the learned model (step S106).

### (Technical Effect)

Next, a technical effect obtained by the information processing system 10 according to the second example embodiment will be described.

As described in FIG. 4 and FIG. 5, in the information processing system 10 according to the second example embodiment, the labeled data and the unlabeled data are converted into the domains that are common to each other. In this way, even when the domains differ between the labeled data and the unlabeled data, appropriate learning may be performed. Specifically, it is possible to prevent an accuracy reduction in accurate data due to the difference between the domains. In addition, it is no longer necessary to use only the data in which the domain is common. For example, it is possible to easily increase the amount of data to be used for learning.

### Third Example Embodiment

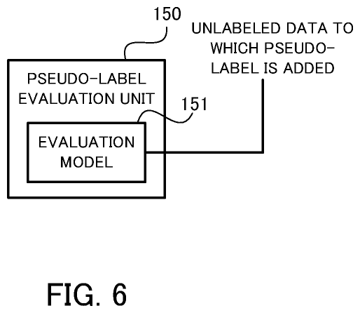

The information processing system 10 according to a third example embodiment will be described with reference to FIG. 6. The third example embodiment shows an example of a method of learning the evaluation model, and may be the same as the first and second example embodiments in the configuration and operation of the system, or the like. For this reason, a part that is different from each of the example embodiments described above will be described in detail below, and a description of other overlapping parts will be omitted as appropriate.

### (Method of Learning Evaluation Model)

With reference to FIG. 6, the method of learning the evaluation model in the information processing system 10 according to the third example embodiment will be specifically described. FIG. 6 is a block diagram illustrating the method of learning the evaluation model in the information processing system according to the third example embodiment.

As illustrated in FIG. 6, in the information processing system 10 according to the third example embodiment, the unlabeled data to which the pseudo-label is added (specifically, the unlabeled data to which the pseudo-label generated by the pseudo-label generation unit 140 is added) are inputted to the pseudo-label evaluation unit 150. Then, the pseudo-label evaluation unit 150 learns an evaluation model 151 by using the unlabeled data to which the pseudo-label is added. The pseudo-label evaluation unit 150 may perform the learning by using the pseudo-label itself, in addition to the unlabeled data to which the pseudo-label is added.

When the evaluation model is learned, the number of epochs is preferably less than 10 to prevent over learning. The number of epochs may be set, for example, on the basis of a batch size or a size of a data set used for the learning. According to a study by the inventor of the present application, it has been found that appropriate learning may be performed in many cases by setting the number of epochs to 1.

### (Technical Effect)

Next, a technical effect obtained by the information processing system 10 according to the third example embodiment will be described.

As described in FIG. 6, in the information processing system 10 according to the third example embodiment, the evaluation model 151 is learned by using the unlabeled data to which the pseudo-label is added. In this way, the evaluation model 151 may be properly learned, and it is thus possible to properly evaluate the pseudo-label.

### Fourth Example Embodiment

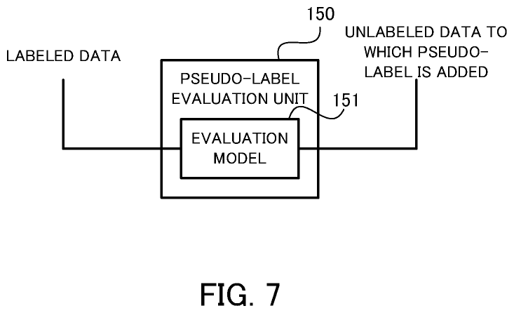

The information processing system 10 according to a fourth example embodiment will be described with reference to FIG. 7. The fourth example embodiment shows an example of the method of learning the evaluation model as in the third example embodiment, and may be the same as the first and second example embodiments in the configuration and operation of the system, or the like. For this reason, a part that is different from each of the example embodiments described above will be described in detail below, and a description of other overlapping parts will be omitted as appropriate.

### (Method of Learning Evaluation Model)

With reference to FIG. 7, the method of learning the evaluation model in the information processing system 10 according to the fourth example embodiment will be specifically described. FIG. 7 is a block diagram illustrating the method of learning the evaluation model in the information processing system according to the fourth example embodiment.

As illustrated in FIG. 7, in the information processing system 10 according to the fourth example embodiment, the labeled data and the unlabeled data to which the pseudo-label is added (specifically, the unlabeled data to which the pseudo-label generated by the pseudo-label generation unit 140 is added) are inputted to the pseudo-label evaluation unit 150. Then, the pseudo-label evaluation unit 150 learns the evaluation model 151, by using the labeled data, and the unlabeled data to which the pseudo-label is added. More specifically, the pseudo-label evaluation unit 150 first learns the evaluation model by using the labeled data. The labelled data used for the learning may be a relatively small amount of data. Thereafter, the pseudo-label evaluation unit 150 learns the evaluation model 151 by using the unlabeled data to which the pseudo-label is added. The unlabeled data used for the learning may be a relatively large amount of data.

### (Technical Effect)

Next, a technical effect obtained by the information processing system 10 according to the fourth example embodiment will be described.

As described in FIG. 7, in the information processing system 10 according to the fourth example embodiment, the evaluation model 151 is first learned by using the labeled data, and is then learned by using the unlabeled data to which the pseudo-label is added. In this way, if the learning is performed by using the labeled data, the evaluation model 151 may be learned more properly, as compared with the case where the labeled data are not used (i.e., when the learning is performed by using only the unlabeled data). Therefore, it is possible to properly evaluate the pseudo-label.

### Fifth Example Embodiment

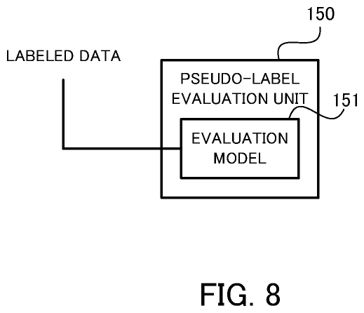

The information processing system 10 according to a fifth example embodiment will be described with reference to FIG. 8. The fifth example embodiment shows an example of the method of learning the evaluation model as in third and fourth example embodiments, and may be the same as the first and second example embodiments in the configuration and operations of the system, or the like. For this reason, a part that is different from each of the example embodiments described above will be described in detail below, and a description of other overlapping parts will be omitted as appropriate.

### (Method of Learning Evaluation Model)

With reference to FIG. 8, the method of learning the evaluation model in the information processing system 10 according to the fifth example embodiment will be specifically described. FIG. 8 is a block diagram illustrating the method of learning the evaluation model in the information processing system according to the fifth example embodiment.

As illustrated in FIG. 8, in the information processing system 10 according to the fifth example embodiment, the labeled data are inputted to the pseudo-label evaluation unit 150. Then, the pseudo-label evaluation unit 150 learns the evaluation model 151 by using the labeled data. The labeled data used for the learning is preferably a relatively large amount of data. When the learning is performed by using the labeled data, the evaluation model 151 is learned in the same manner as the teacher model in the teacher model learning unit 130 (see FIG. 2). Therefore, in this case, it is configured such that there are two teacher models. Specifically, it is configured such that the pseudo-label generated by one teacher model is evaluated by the other teacher model.

### (Technical Effect)

Next, a technical effect obtained by the information processing system 10 according to the fifth example embodiment will be described.

As described in FIG. 8, in the information processing system 10 according to the fifth example embodiment, the evaluation model 151 is learned by using the labeled data. In this way, the evaluation model 151 may be properly learned, and it is thus possible to properly evaluate the pseudo-label.

### Sixth Example Embodiment

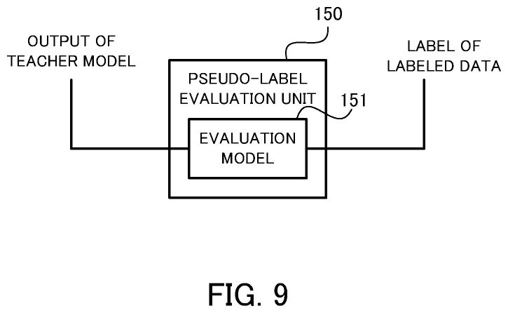

The information processing system 10 according to a sixth example embodiment will be described with reference to FIG. 9. The sixth example embodiment shows an example of the method of learning the evaluation model as in the third to fifth example embodiments, and may be the same as t the first and second example embodiments in the configuration and operation of the system, or the like. For this reason, a part that is different from each of the example embodiments described above will be described in detail below, and a description of other overlapping parts will be omitted as appropriate.

### (Method of Learning Evaluation Model)

With reference to FIG. 9, the method of learning the evaluation model in the information processing system 10 according to the sixth example embodiment will be specifically described. FIG. 9 is a block diagram illustrating the method of learning the evaluation model in the information processing system according to the sixth example embodiment.

As illustrated in FIG. 9, in the information processing system 10 according to the ninth example embodiment, an output of the teacher model (in other words, the label estimated by the teacher model from the unlabeled data) and the label of the labeled data are inputted to the pseudo-label evaluation unit 150. Then, the pseudo-label evaluation unit 150 first uses only the labeled data as an input and learns the evaluation model 151 by calculating a difference between the output of the teacher model and the label of the labeled data. The pseudo-label evaluation unit 150 evaluates the pseudo-label, by using a value of the difference as quality. Specifically, the pseudo-label evaluation unit 150 inputs the pseudo-labeled data to the learned evaluation model 151 to estimate the difference between the estimated (pseudo) label and the true/genuine label, evaluates that an estimation accuracy of the teacher model is poor for those having a large value of the calculated difference, and evaluates that the estimation accuracy of the teacher model is good for those having a small value of the calculated difference.

### (Technical Effect)

Next, a technical effect obtained by the information processing system 10 according to the sixth example embodiment will be described.

As described in FIG. 9, in the information processing system 10 according to the sixth example embodiment, the evaluation model 151 is learned by using the difference between the output of the teacher model and the label of the labeled data. In this way, the evaluation model 151 may be properly learned, and it is thus possible to evaluate the pseudo-label.

### Seventh Example Embodiment

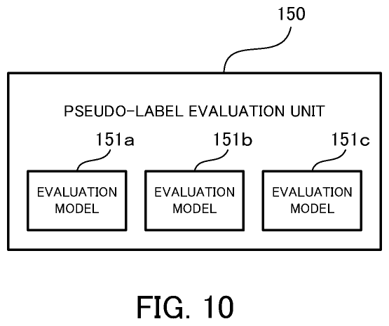

The information processing system 10 according to a seventh example embodiment will be described with reference to FIG. 10. The seventh example embodiment shows a configuration example of the pseudo-label evaluation unit 150, and may be the same as the first to sixth example embodiments in the configuration and various operations of the system, or the like. For this reason, a part that is different from each of the example embodiments described above will be described in detail below, and a description of other overlapping parts will be omitted as appropriate.

### (Configuration of Pseudo-Label Evaluation Unit)

First, a configuration of the pseudo-label evaluation unit 150 in the information processing system 10 according to the seventh example embodiment will be specifically described with reference to FIG. 10. FIG. 10 is a block diagram illustrating the configuration of the model evaluation unit in the information processing system according to the seventh example embodiment.

As illustrated in FIG. 10, in the information processing system 10 according to the seventh example embodiment, the pseudo-label evaluation unit 150 includes a plurality of evaluation models 151. Although the pseudo-label evaluation unit 150 includes three evaluation models 151a, 151b, 151c here, the number is not particularly limited thereto. For example, the pseudo-label evaluation unit 150 may include two evaluation models 151, or may include four or more evaluation models 151.

Each of the plurality of evaluation models 151 is a model separately learned. The plurality of evaluation models 151, however, may be learned by using a common data set, or may be learned by using data sets that are different from each other. The plurality of evaluation models 151 may perform the learning by using perturbated data. A method of perturbing data is not particularly limited, but may include, for example, a method of shifting or blurring pixels, or cutting off a part of the pixels.

Furthermore, the plurality of evaluation models 151 may be learned by the learning methods described in the third to sixth example embodiments. In this case, each of the plurality of evaluation models 151 may be learned in a different learning method. For example, the evaluation model 151a may be learned in the learning method described in the third example embodiment (i.e., the learning method using the unlabeled data: see FIG. 6), the evaluation model 151b may be learned in the learning method described in the fourth example embodiment (i.e., the learning method using the labeled data and the unlabeled data: see FIG. 7), and the evaluation model 151c may be learned in the learning method described in the fifth example embodiment (i.e., the learning method using the labeled data: see FIG. 8).

The pseudo-label evaluation unit 150 evaluates the pseudo-label by using the plurality of evaluation models 151. Specifically, the pseudo-label evaluation unit 150 first outputs an evaluation result from each of the plurality of evaluation models 151, and outputs one final evaluation result in accordance with the plurality of evaluation results. More specifically, an overall evaluation result may be outputted by majority vote of the respective evaluation results of the plurality of evaluation models 151, or by calculating the average value.

### (Technical Effect)

Next, a technical effect obtained by the information processing system 10 according to the seventh example embodiment will be described.

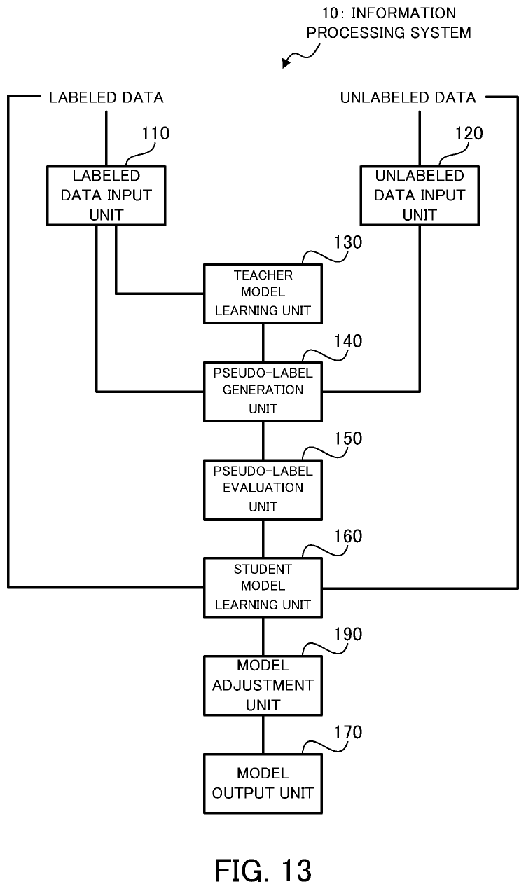

As described in FIG. 13, in the information processing system 10 according to the seventh example embodiment, the pseudo-label is evaluated by using the plurality of evaluation models 151. In this way, the pseudo-label may be evaluated more properly, as compared with the case where only one evaluation model is used for the evaluation.

### Eighth Example Embodiment

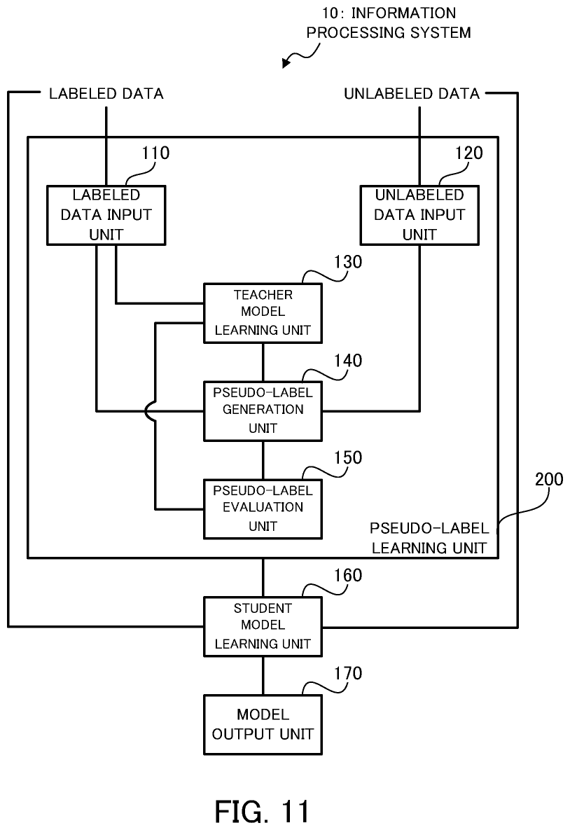

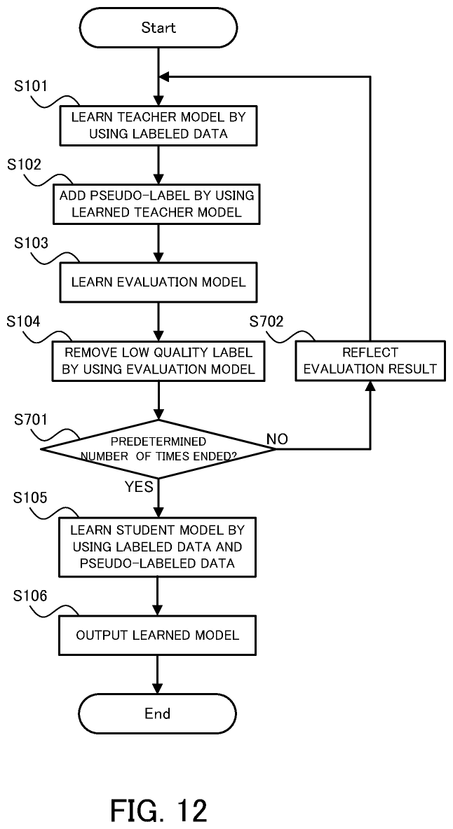

The information processing system 10 according to an eighth example embodiment will be described with reference to FIG. 11 and FIG. 12. The eighth example embodiment is partially different from the first to seventh example embodiments only in the configuration and operation, and may be the same as the first to seventh example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the eighth example embodiment will be described with reference to FIG. 11. FIG. 11 is a block diagram illustrating the functional configuration of the information processing system according to the eighth example embodiment. In FIG. 11, the same components as those illustrated in FIG. 2 carry the same reference numerals.

As illustrated in FIG. 11, the information processing system 10 according to the eighth example embodiment includes, as processing blocks for realizing the functions thereof, the labeled data input unit 110, the unlabeled data input unit 120, the teacher model learning unit 130, the pseudo-label generation unit 140, the pseudo-label evaluation unit 150, the student model learning unit 160, and the model output unit 170. Especially in the eighth example embodiment, of the above-described components, the labeled data input unit 110, the unlabeled data input unit 120, the teacher model learning unit 130, the pseudo-label generation unit 140, and the pseudo-label evaluation unit 150 are configured as a pseudo-label learning unit 200.

The pseudo-label learning unit 200 is configured to more properly perform the learning about the pseudo-label, by repeatedly performing the learning of the teacher model by the teacher model learning unit 130, the generation of the pseudo-label by the pseudo-label generation unit 140, and the pseudo-label evaluation by the pseudo-label evaluation unit 150. The pseudo-label learning unit 200 is configured to learn the teacher model by reflecting the evaluation result of the pseudo-label evaluation unit 150. For example, the teacher model may be re-learned, by back-propagating an error calculated by the pseudo-label evaluation unit 150 to the teacher model learning unit 130. The pseudo-label learning unit 200 is set to repeat a series of processing steps until a predetermined number of times is reached. The predetermined number of times may be a value obtained by prior simulation or the like.

### (Flow of Operation)

Next, a flow of operation of the information processing system 10 according to the eighth example embodiment will be described with reference to FIG. 12. FIG. 12 is a flowchart illustrating the flow of the operation of the information processing system according to the eighth example embodiment. In FIG. 12, the same steps as those illustrated in FIG. 3 carry the same reference numerals.

As illustrated in FIG. 12, in operation of the information processing system 10 according to the eighth example embodiment, first, the teacher model learning unit 130 learns the teacher model by using the labeled data inputted from the labeled data input unit 110 (step S101). Then, the pseudo-label generation unit 140 generates the pseudo-label by using the learned teacher model, and adds the pseudo-label to the unlabeled data inputted from the unlabeled data input unit 120 (step S102).

Subsequently, the pseudo-label evaluation unit 150 learns the evaluation model (step S103). Then, the pseudo-label evaluation unit 150 removes a low-quality pseudo-label of the pseudo-labels generated by the pseudo-label generation unit 140 (step S104).

Here, the information processing system 10 according to the eighth example embodiment determines whether or not a series of processing steps up to this point is repeated a predetermined number of times (step S701). When it is determined that the series of processing steps is not repeated the predetermined number of times (step S701: NO), from the evaluation result of the pseudo-label evaluation unit 150 is reflected (step S702), and the process is performed from the step S101 again.

On the other hand, when it is determined that the series of processing steps is repeated the predetermined number of times (step S701: YES), a final evaluation pseudo-label is outputted, and the student model learning unit 160 learns the student model, by using the labeled data, and the pseudo-labeled data in which the evaluation pseudo-label is added (step S105). Thereafter, the model output unit 170 outputs the learned model (step S106).

### (Technical Effect)

Next, a technical effect obtained by the information processing system 10 according to the eighth example embodiment will be described.

As described in FIG. 11 and FIG. 12, in the information processing system 10 according to the eighth example embodiment, the learning about the pseudo-label (specifically, the learning of the teacher model, the generation of the pseudo-label, and the evaluation of the pseudo-label) is repeatedly performed in the pseudo-label learning unit 200. In this way, each model is learned to be in a more appropriate state, and it is thus possible to output a more appropriate pseudo-label (i.e., the evaluation pseudo-label).

### Ninth Example Embodiment

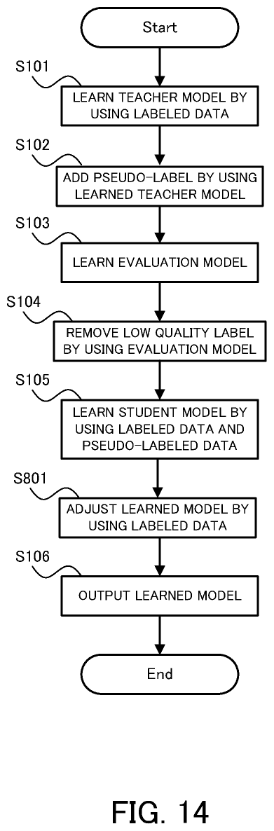

The information processing system 10 according to a ninth example embodiment will be described with reference to FIG. 13 and FIG. 14. The information processing system 10 according to the ninth example embodiment is partially different from the first to eighth example embodiments only in the configuration and operation, and may be the same as the first to eighth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the ninth example embodiment will be described with reference to FIG. 13. FIG. 13 is a block diagram illustrating the functional configuration of the information processing system according to the ninth example embodiment. In FIG. 13, the same components as those illustrated in FIG. 2 carry the same reference numerals.

As illustrated in FIG. 13, the information processing system 10 according to the ninth example embodiment includes, as processing blocks for realizing the functions thereof, the labeled data input unit 110, the unlabeled data input unit 120, the teacher model learning unit 130, the pseudo-label generation unit 140, the pseudo-label evaluation unit 150, the student model learning unit 160, the model output unit 170, and a model adjustment unit 190. That is, the information processing system 10 according to the ninth example embodiment further includes the model adjustment unit 190, in addition to the configuration in the first example embodiment (see FIG. 2).

The model adjustment unit 190 is configured to adjust a part of layers of the learned model, by using the labeled data. Specifically, the model adjusting unit 190 is configured to perform Fine Tuning on the learned model.

### (Flow of Operation)

Next, a flow of operation of the information processing system 10 according to the ninth example embodiment will be described with reference to FIG. 14. FIG. 14 is a flowchart illustrating the flow of the operation of the information processing system according to the ninth example embodiment. In FIG. 14, the same steps as those illustrated in FIG. 3 carry the same reference numerals.

As illustrated in FIG. 14, in operation of the information processing system 10 according to the ninth example embodiment, first, the teacher model learning unit 130 learns the teacher model by using the labeled data inputted from the labeled data input unit 110 (step S101). Then, the pseudo-label generation unit 140 generates the pseudo-label by using the learned teacher model, and adds the pseudo-label to the unlabeled data inputted from the unlabeled data input unit 120 (step S102).

Subsequently, the pseudo-label evaluation unit 150 learns the evaluation model (step S103). Then, the pseudo-label evaluation unit 150 removes a low-quality pseudo-label of the pseudo-labels generated by the pseudo-label generation unit 140 (step S104).

Subsequently, the student model learning unit 160 learns the student model, by using the labeled data, and the pseudo-labeled data in which the evaluation pseudo-label is added (step S105). Especially in the ninth example embodiment, the model adjustment unit 190 adjusts the learned model by using the labeled data (step S801). Thereafter, the model output unit 170 outputs the adjusted learned model (step S106).

### (Technical Effect)

Next, a technical effect obtained by the information processing system 10 according to the ninth example embodiment will be described.

As described in FIG. 13 and FIG. 14, in the information processing system 10 according to the ninth example embodiment, the model is adjusted before the learned model is outputted. In this way, it is possible to make the learned model to be outputted, more appropriate.

A processing method in which a program for allowing the configuration in each of the example embodiments to operate so as to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. An information processing system, an information processing method, and a recording medium with such changes are also intended to be within the technical scope of this disclosure.

### SUPPLEMENTARY NOTES

The example embodiments described above may be further described as, but not limited to, the following Supplementary Notes below.

### Supplementary Note 1

An information processing system according to Supplementary Note 1 is an information processing system including: a data input unit that inputs labeled data and unlabeled data; a pseudo-label addition unit that adds a pseudo-label to the unlabeled data, by using a teacher model learned by using the labeled data; a pseudo-label evaluation unit that evaluates the pseudo-label added to the unlabeled data, by using an evaluation model learned by using at least one of the labeled data and the unlabeled data, and outputs the pseudo-label that reaches a predetermined evaluation criterion, as an evaluation pseudo-label; a student model learning unit that learns a student model, by using the labeled data, and pseudo-labeled data obtained by adding the evaluation pseudo-label to the labeled data; and a model output unit that outputs the learned student model.

### Supplementary Note 2

An information processing system according to Supplementary Note 2 is the information processing system according to Supplementary Note 1, further including a domain conversion unit that converts the unlabeled data and the labeled data inputted to the data input unit, into domains that are common to each other.

### Supplementary Note 3

An information processing system according to Supplementary Note 3 is the information processing system according to Supplementary Note 1 or 2, wherein the evaluation model is learned by using only the unlabeled data.

### Supplementary Note 4

An information processing system according to Supplementary Note 4 is the information processing system according to Supplementary Note 1 or 2, wherein the evaluation model is learned by using a part of the labeled data and is then learned by using the unlabeled data.

### Supplementary Note 5

An information processing system according to Supplementary Note 5 is the information processing system according to Supplementary Note 1 or 2, wherein the evaluation model is learned by using only the labeled data.

### Supplementary Note 6

An information processing system according to Supplementary Note 6 is the information processing system according to Supplementary Note 1 or 2, wherein the pseudo-label evaluation unit is learned by using a difference between an output of the teacher model and a label added to the labeled data.

### Supplementary Note 7

An information processing system according to Supplementary Note 7 is the information processing system according to any one of Supplementary Notes 1 to 6, wherein the pseudo-label evaluation unit evaluates the pseudo-label by using a plurality of evaluation models that are separately learned.

### Supplementary Note 8

An information processing system according to Supplementary Note 8 is the information processing system according to any one of Supplementary Notes 1 to 7, further including a teacher model learning unit that learns the teacher model by using the labeled data, wherein the teacher model learning unit re-learns the teacher model by using an evaluation result of the pseudo-label evaluation unit.

### Supplementary Note 9

An information processing system according to Supplementary Note 9 is the information processing system according to any one of Supplementary Notes 1 to 8, further including an adjustment unit that learns a part layers of the learned student model, by using the labeled data.

### Supplementary Note 10

An information processing method according to Supplementary Note 10 is an information processing method including: inputting labeled data and unlabeled data; adding a pseudo-label to the unlabeled data, by using a teacher model learned by using the labeled data; evaluating the pseudo-label added to the unlabeled data, by using an evaluation model learned by using at least one of the labeled data and the unlabeled data, and outputting the pseudo-label that reaches a predetermined evaluation criterion, as an evaluation pseudo-label; learning a student model, by using the labeled data, and pseudo-labeled data obtained by adding the evaluation pseudo-label to the labeled data; and outputting the learned student model.

### Supplementary Note 11

A recording medium according to Supplementary Note 11 is a recording medium on which a computer program that allows a computer to execute an information processing method is recorded, the information processing method including: inputting labeled data and unlabeled data; adding a pseudo-label to the unlabeled data, by using a teacher model learned by using the labeled data; evaluating the pseudo-label added to the unlabeled data, by using an evaluation model learned by using at least one of the labeled data and the unlabeled data, and outputting the pseudo-label that reaches a predetermined evaluation criterion, as an evaluation pseudo-label; learning a student model, by using the labeled data, and pseudo-labeled data obtained by adding the evaluation pseudo-label to the labeled data; and outputting the learned student model.

### Supplementary Note 12

A computer program according to Supplementary Note 12 is a computer program that allows a computer to execute an information processing method, the information processing method including: inputting labeled data and unlabeled data; adding a pseudo-label to the unlabeled data, by using a teacher model learned by using the labeled data; evaluating the pseudo-label added to the unlabeled data, by using an evaluation model learned by using at least one of the labeled data and the unlabeled data, and outputting the pseudo-label that reaches a predetermined evaluation criterion, as an evaluation pseudo-label; learning a student model, by using the labeled data, and pseudo-labeled data obtained by adding the evaluation pseudo-label to the labeled data; and outputting the learned student model.

### DESCRIPTION OF REFERENCE CODES

10 Information processing system
11 Processor
110 Labeled data input unit
120 Unlabeled data input unit
130 Teacher model learning unit
140 Pseudo-label generation unit
150 Pseudo-label evaluation unit
151 Evaluation model
160 Student model learning unit
170 Model output unit
180 Domain conversion unit
190 Model adjustment unit
200 Pseudo-label learning unit

What is claimed is:

1. An information processing system comprising:
at least one memory that is configured to store instructions; and
at least one processor that is configured to execute the instructions to input labeled data and unlabeled data;
add a pseudo-label to the unlabeled data, by using a teacher model learned by using the labeled data;
evaluate the pseudo-label added to the unlabeled data, by using an evaluation model learned by using at least one of the labeled data and the unlabeled data, and output the pseudo-label that reaches a predetermined evaluation criterion, as an evaluation pseudo-label;
learn a student model, by using the labeled data, and pseudo-labeled data obtained by adding the evaluation pseudo-label to the labeled data; and
output the learned student model.

2. The information processing system according to claim 1, wherein the at least one processor is configured to execute the instructions to convert the unlabeled data and the labeled data, into domains that are common to each other.

3. The information processing system according to claim 1, wherein the evaluation model is learned by using only the unlabeled data.

4. The information processing system according to claim 1, wherein the evaluation model is learned by using a part of the labeled data and is then learned by using the unlabeled data.

5. The information processing system according to claim 1, wherein the evaluation model is learned by using only the labeled data.

6. The information processing system according to claim 1, wherein the evaluation model is learned by using a difference between an output of the teacher model and a label added to the labeled data.

7. The information processing system according to claim 1, wherein the at least one processor is configured to execute the instructions to evaluate the pseudo-label by using a plurality of evaluation models that are separately learned.

8. The information processing system according to claim 1, wherein the at least one processor is configured to execute the instructions to
learn the teacher model by using the labeled data, and
re-learn the teacher model by using an evaluation result of the evaluation model.

9. The information processing system according to claim 1, wherein the at least one processor is configured to execute the instructions to learn a part layers of the learned student model, by using the labeled data.

10. An information processing method comprising:
inputting labeled data and unlabeled data;
adding a pseudo-label to the unlabeled data, by using a teacher model learned by using the labeled data;
evaluating the pseudo-label added to the unlabeled data, by using an evaluation model learned by using at least one of the labeled data and the unlabeled data, and outputting the pseudo-label that reaches a predetermined evaluation criterion, as an evaluation pseudo-label;
learning a student model, by using the labeled data, and pseudo-labeled data obtained by adding the evaluation pseudo-label to the labeled data; and
outputting the learned student model.

11. A non-transitory recording medium on which a computer program that allows a computer to execute an information processing method is recorded, the information processing method including:
inputting labeled data and unlabeled data;
adding a pseudo-label to the unlabeled data, by using a teacher model learned by using the labeled data;
evaluating the pseudo-label added to the unlabeled data, by using an evaluation model learned by using at least one of the labeled data and the unlabeled data, and outputting the pseudo-label that reaches a predetermined evaluation criterion, as an evaluation pseudo-label;
learning a student model, by using the labeled data, and pseudo-labeled data obtained by adding the evaluation pseudo-label to the labeled data; and
outputting the learned student model.
